(19) United States
(12) Patent Application Publication
(10) Pub. No.: US 2026/0355860 A1
(43) Pub. Date: Nov. 12, 2026

(54) NOZZLE EXCHANGE COUPLING HAVING A LIFT MOTOR AND A ROTARY MOTOR AND METHOD FOR MOVING A NOZZLE EXCHANGE COUPLING

(71) Applicant: TRUMPF WERKZEUGMASCHINEN SE + CO. KG, Ditzingen (DE)

(72) Inventors: Wolfgang ANDREASCH, Weinstadt (DE); Martin BLOCK, Haigerloch-Weildorf (DE)

(21) Appl. No.: 19/713,784

(22) Filed: Jun. 19, 2026

Related U.S. Application Data
(63) Continuation of application No. PCT/EP2024/084765, filed on Dec. 5, 2024.

(30) Foreign Application Priority Data
Dec. 20, 2023 (DE) 10 2023 136 139.2

(51) Int. Cl. B23K 26/14

(52) U.S. Cl. CPC B23K 26/1438; B23K 26/1462

(57) ABSTRACT

A nozzle exchange coupling for coupling a protective gas nozzle to a laser optics system, including a motor unit with a lift motor configured to generate a lift movement of the protective gas nozzle and a rotary motor configured to generate a rotary movement of the protective gas nozzle. The nozzle exchange coupling further includes a transmission with an input sleeve which is coupled at least to the lift motor and an output sleeve which is coupled at least to the rotary motor, the output sleeve being configured to contribute to supplying of a protective gas to the protective gas nozzle.

### CROSS REFERENCE TO RELATED APPLICATIONS

This application is a continuation of International Application No. PCT/EP2024/084765 (WO 2025/131733A1 ), filed on Dec. 5, 2024, and claims benefit to German Patent Application No. DE 10 2023 136 139.2, filed on Dec. 20, 2023. The aforementioned applications are hereby incorporated by reference herein.

### FIELD

The present invention relates to a nozzle exchange coupling for coupling a protective gas nozzle to a laser optics system and a method for moving a nozzle exchange coupling.

### BACKGROUND

Laser systems, in particular multi-axis laser welding systems, have become an indispensable technology in many industries in recent years. They can offer high precision and high flexibility and can make it possible to efficiently machine, in particular weld, a workpiece. Laser welding systems include a protective gas nozzle by means of which process media, such as a protective gas and/or a welding medium, are conveyed to the location of the laser welding process. The protective gas nozzle is located outside of a laser optics system, in particular a laser welding optics system, and can impair the kinematic flexibility of the laser optics system.

Chinese patent application CN 104014932 A discloses a nozzle device, which can rotate a gas nozzle around a laser axis by means of a central rotary drive in order to adapt the direction from which a gas flows out of the gas nozzle to different operating stages.

European patent application EP 3 466 599 A1 discloses an adjustment device, which can adjust a nozzle device along a laser axis in a vertical direction. The nozzle device can also be arranged to be rotatable and moveable around a welding head.

### SUMMARY

In an embodiment, the present disclosure provides a nozzle exchange coupling for coupling a protective gas nozzle to a laser optics system, comprising a motor unit with a lift motor configured to generate a lift movement of the protective gas nozzle and a rotary motor configured to generate a rotary movement of the protective gas nozzle. The nozzle exchange coupling further comprises a transmission with an input sleeve which is coupled at least to the lift motor and an output sleeve which is coupled at least to the rotary motor, the output sleeve being configured to contribute to supplying of a protective gas to the protective gas nozzle.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a nozzle exchange coupling with a motor unit, to which a protective gas nozzle is connected;

FIG. 2 shows a protective gas nozzle colliding with a fillet of a workpiece and a protective gas nozzle which has performed a lift movement away from the workpiece;

FIG. 3 shows a perspective view, in which the protective gas nozzle is connected to the nozzle exchange coupling;

FIG. 4 shows a first sectional view through the lift motor, whose output shaft meshes with an input sleeve;

FIG. 5 shows a second sectional view through the rotary motor, whose output shaft meshes with an output sleeve;

FIG. 6 shows a shielding gas routing through the nozzle exchange coupling;

FIG. 7 shows a compressed air routing through the nozzle exchange coupling;

FIG. 8 shows a perspective outer view of the nozzle exchange coupling; and

FIG. 9 shows a nozzle system with the nozzle exchange coupling, a laser optics system and the protective gas nozzle.

### DETAILED DESCRIPTION

In an embodiment, the present disclosure provides an improved nozzle exchange coupling for coupling a protective gas nozzle to a laser optics system and an improved method for moving a nozzle exchange coupling. In particular, an embodiment provides a nozzle exchange coupling which ensures kinematic flexibility of the protective gas nozzle relative to the laser optics system. Furthermore, the reliability and precision of the machining should not be affected by the kinematic flexibility. An embodiment also provides a robust, error-free movement of the nozzle exchange coupling relative to the laser optics system. Embodiments of the present disclosure also provide a compact, space-saving solution.

A nozzle exchange coupling is provided for coupling a protective gas nozzle to a laser optics system. The protective gas nozzle can be designed to deliver protective gas as required by the process to a processing location, in particular to a weld seam. The protective gas can be a shielding gas which protects the processing location from oxidation and/or premature aging, so that the molten material does not come into contact with an ambient gas, such as nitrogen, oxygen, or hydrogen. The nozzle exchange coupling can also carry a compressed air gas which protects a laser optics system, in particular a laser welding optics system, by supplying compressed air perpendicular to a laser axis and thus protecting the laser optics system from, for example, rising metal vapors and/or welding fumes, flying particles and/or the ejection of molten metal. The laser optics system can align and focus the laser beam, in particular, the laser welding beam, as required by the process, on the processing location. The laser optics system can have an optical rotary module which ensures rotation of the laser optics system. The nozzle exchange coupling can couple the protective gas nozzle to the laser optics system in such a way that a transmission ratio as well as rotational movement of the laser optics system is selectively transmitted to the protective gas nozzle and the nozzle exchange coupling can also perform a lift movement and/or rotary movement independent of the laser optics system. The nozzle exchange coupling can ensure a detachable connection between the protective gas nozzle and the laser optics system.

The nozzle exchange coupling has a motor unit with a lift motor to generate a lift movement of the protective gas nozzle and a rotary motor to generate a rotary movement of the protective gas nozzle. The lift motor and the rotary motor can be separate motors, which are housed in one housing or in two separate housings. The lift motor and the rotary motor can be identical in construction. Each can have an output shaft which performs a rotary movement when driven accordingly. The rotary movement of the protective gas nozzle can occur around a rotational axis which corresponds to the axis of the laser beam. The lift movement of the protective gas nozzle can extend along the axis of the laser beam in a vertical direction. A transmission unit is arranged between the lift motor and the protective gas nozzle, as well as between the rotary motor and the protective gas nozzle.

The nozzle exchange coupling has a transmission unit with an input sleeve which is coupled at least to the lift motor and an output sleeve which is coupled at least to the rotary motor, the output sleeve contributing to the supply of a protective gas to the protective gas nozzle. The transmission unit can have a multitude of components. For example, the transmission unit has a rotary motor transmission input shaft which meshes with a rotary motor output shaft and a lift motor transmission input shaft which meshes with a lift motor output shaft. The input sleeve can be designed as a threaded sleeve onto which a rotation of the lift motor is transferred, for example by means of an intermediate transmission. The corresponding rotation of the input sleeve can rotate around the axis of the laser beam. The position of the input sleeve in the vertical direction can remain constant relative to the laser optics system. The output sleeve can be designed as a drive nut onto which a rotation of the rotary motor is transferred, for example by means of an intermediate transmission. The corresponding rotation of the output sleeve can rotate around the axis of the laser beam. The position of the output sleeve in the vertical direction can vary or remain constant relative to the laser optics system, for example depending on the input sleeve. The output sleeve can be coupled to the lift motor via the input sleeve. Therefore, the transmission unit can implement a kinematic coupling between the lift motor and the rotary motor.

Thus, the nozzle exchange coupling is able to achieve kinematic flexibility between the protective gas nozzle and the laser optics system. The kinematic flexibility contributes to more precise workpiece processing, in particular by enabling laser welding to be carried out at a substantially constant position of the laser beam waist (focus position) relative to the workpiece. For example, if the laser optics system is moved during the component processing into a position which requires the protective gas nozzle to be moved to avoid a collision with the workpiece, the nozzle exchange coupling enables this movement without moving the laser beam itself. Therefore, the focus position relative to the workpiece does not change, which enables precise workpiece processing. The kinematic flexibility also contributes to high-quality laser processing, in particular by reducing the thermal and/or chemical stress on a laser weld seam. The nozzle exchange coupling and/or the protective gas nozzle can supply the compressed air gas and/or protective gas to the processing location. A workpiece to be machined can have a geometry such that gas exiting the nozzle exchange coupling, for example compressed air gas in a cross-jet configuration, is caused to become turbulent, for instance in a workpiece fillet, i.e., an internal angle of the workpiece. The turbulence impairs the thermal and/or chemical stress on the laser weld seam. The nozzle exchange coupling enables such movement that no turbulence occurs with corresponding workpiece geometries and thus contributes to high-quality laser processing.

In an embodiment, the input sleeve and the output sleeve are connected via a transmission, in particular a movement thread, which is prepared to convert a rotation of the input sleeve into the lift movement of the protective gas nozzle. For this purpose, the output sleeve can be locked in a rotationally fixed position relative to the input sleeve. For example, a fork ring can couple the output sleeve at least indirectly with the rotary motor, so that, when the rotary motor is stationary, rotation of the output sleeve is prevented and thus, when the lift motor is rotating, a pure stroke of the nozzle exchange coupling is achieved. The movement thread is designed for reliably and space-savingly transmitting power between the input sleeve and the output sleeve.

In an embodiment, the lift motor and the rotary motor are kinematically coupled. Additionally or alternatively, the lift motor and the rotary motor can be controlled separately. “Kinematic coupling” can mean that a movement of one motor causes a desired movement of the nozzle exchange coupling, depending on the movement of the other motor. The lift motor and the rotary motor can be connected to the same control unit. If they can be controlled separately, the respective control signals are coordinated with one another. By controlling the nozzle exchange coupling using the lift motor and the rotary motor, precise movement of the nozzle exchange coupling is enabled depending on the respective position of the laser optics system relative to the workpiece. This increases safety and further contributes to precise laser processing.

In an embodiment, the lift motor and the rotary motor are connected to a control unit, via which the lift motor and the rotary motor can be controlled in such a way that the protective gas nozzle optionally performs a pure rotary movement, a pure lift movement or a combined lift and rotary movement. The nozzle exchange coupling can include the control unit. A pure rotary movement can mean that the nozzle exchange coupling rotates exclusively relative to the laser optics system and does not perform any lift movement. Accordingly, a pure lift movement can mean that the nozzle exchange coupling exclusively performs a lift movement relative to the laser optics system and does not perform a rotary movement. Ultimately, a combined lift and rotary movement can mean that a movement has both a lift and rotary movement component.

In an embodiment, during pure rotary movement, a rotation of the lift motor is synchronized with a rotation of the rotary motor, in particular to compensate for a displacement of the movement thread and thus of the protective gas nozzle. For pure rotary movement, both the lift motor and the rotary motor perform a rotation. These rotations are synchronous and dependent on the transmission ratio of the movement thread. The faster the rotary motor rotates in a first direction, the faster the lift motor rotates in an opposite direction in order to compensate for the rotation of the rotary motor and to compensate for the stroke caused by the movement thread. This further contributes to kinematic flexibility.

In an embodiment, during the combined lift and rotary movement, the rotary motor rotates and the lift motor remains stationary. Therefore, for the combined lift and rotary movement, only the rotary motor performs a rotation. The rotation of the lift motor is synchronous with the rotation of the rotary motor insofar as the lift motor is stationary when a desired rotation is achieved through the transmission ratio of the movement thread. If a different rotation than that achieved by the transmission ratio of the movement thread is desired, the lift motor can perform an additional rotation. This further contributes to kinematic flexibility.

In an embodiment, during the pure lift movement, the lift motor rotates and the rotary motor remains stationary, thereby preventing, in particular, rotation of the output sleeve. The output sleeve can include a fork ring, through which it is at least indirectly coupled to the rotary motor. When the input sleeve rotates due to the rotation of the lift motor, part of the movement thread also rotates, namely the part which is connected to the input sleeve. Because the rotary motor is stationary, and thus the part of the movement thread connected to the output sleeve is also stationary, a pure lift movement is made possible.

In an embodiment, the output sleeve has a drive nut and a compressed air supply sleeve, wherein in particular the drive nut is arranged at least partially radially outside the input sleeve and/or in particular the compressed air supply sleeve is arranged at least partially radially inside the input sleeve. The drive nut allows for space-saving integration of the movement thread into the nozzle exchange coupling. The compressed air supply sleeve enables space-saving compressed air routing through the nozzle exchange coupling. By arranging the drive nut and the compressed air supply sleeve on two sides of the input sleeve, the space-saving and robust design of the nozzle exchange coupling is further enhanced.

In an embodiment, the drive nut and the compressed air supply sleeve are rigidly connected to each other via a fork ring. Every rotary movement, in particular every movement, of one component is transmitted to the other component via the fork ring. The fork ring can be a ring-shaped element with two protrusions which engage in a corresponding geometry of the compressed air supply sleeve. This modularity in the design of the nozzle exchange coupling allows for a clear assignment of a component to a function, which facilitates the flow of force within the nozzle exchange coupling.

In an embodiment, the input sleeve includes an integrated gas routing designed to supply the protective gas to the protective gas nozzle. Alternatively or additionally, the rotary movement of the output nozzle can be performed as a continuous rotary movement. The integrated gas routing enables a robust and space-saving gas routing within the nozzle exchange coupling. Furthermore, it enables the nozzle exchange coupling to implement the gas routing without hoses. By eliminating all hoses within the nozzle exchange coupling, a continuous rotary movement of the nozzle exchange coupling is achievable. A rotation of up to 360° due to twisting hoses is therefore no longer a constraint.

In an embodiment, the compressed air sleeve is designed as a crossjet sleeve, which includes an integrated compressed air routing which is configured to supply compressed air as a crossjet transverse to a longitudinal axis of the nozzle exchange coupling, i.e., the axis of the laser beam. The integrated compressed air routing enables a robust and space-saving compressed air routing within the nozzle exchange coupling. Furthermore, it enables the nozzle exchange coupling to implement the compressed air routing without hoses. The crossjet contributes to ensuring that the nozzle exchange coupling meets the highest quality requirements of laser processing.

The disclosure further relates to a nozzle system comprising a nozzle exchange coupling according to the present disclosure and the laser optics system, in particular laser welding optics system. The motor unit of the nozzle system is independent of the laser optics system, so that the protective gas nozzle can be moved relative to the laser optics system by means of the lift movement and/or the rotary movement. The movement of the nozzle exchange coupling therefore has no influence on the position of the laser beam relative to the workpiece. The focus position of the laser beam thus remains unchanged, which facilitates the processing of the workpiece. The nozzle system is therefore able to adjust the position of the protective gas nozzle for complex component geometries, for example, to prevent a collision, without affecting the laser processing itself. The disclosure also relates to a laser system with a nozzle system as disclosed.

The disclosure also provides a method for moving a nozzle exchange coupling, in particular according to this disclosure. The method has the step of performing a pure lift movement of a protective gas nozzle, in particular by exclusively rotating a lift motor. Alternatively or additionally, the method includes the step of performing a combined lift and rotary movement of the protective gas nozzle, in particular by exclusively rotating a rotary motor. Alternatively or additionally, the method includes the step of performing a pure rotary movement of the protective gas nozzle by rotating the rotary motor and the lift motor. The protective gas nozzle can therefore be moved and rotated as required by the respective operating state, i.e., the position of the protective gas nozzle relative to the workpiece. This ensures kinematic flexibility, enabling faster and more precise machining of a workpiece. Whether the nozzle exchange coupling performs the pure lift movement, the pure rotary movement, or the combined lift and rotary movement depends on control by a control unit. This can control the lift motor and the rotary motor independently of each other. The control system takes into account the desired position of the protective gas nozzle relative to the workpiece.

Thus, the method is able to achieve kinematic flexibility between the protective gas nozzle and the laser optics system. The kinematic flexibility contributes to more precise workpiece processing, in particular by enabling laser welding to be carried out at a substantially constant position of the laser beam waist (focus position) relative to the workpiece. For example, if the laser optics system is moved during the component processing into a position which requires the protective gas nozzle to be moved to avoid a collision with the workpiece, the method enables this movement without moving the laser beam itself. Therefore, the focus position relative to the workpiece does not change, which enables precise workpiece processing. The kinematic flexibility also contributes to high-quality laser processing, in particular by reducing the thermal and/or chemical stress on a laser weld seam. The nozzle exchange coupling and/or the protective gas nozzle can supply the compressed air gas and/or protective gas to the processing location. A workpiece to be machined can have a geometry such that compressed air gas exiting the nozzle exchange coupling is caused to become turbulent, for instance in a workpiece fillet, i.e., an internal angle of the workpiece. The turbulence impairs the thermal and/or chemical stress on the laser weld seam. The method enables such movement that no turbulence occurs with corresponding workpiece geometries and thus contributes to high-quality laser processing.

In an embodiment, during pure rotary movement, a rotation of the lift motor is synchronized with a rotation of the rotary motor, in particular to compensate for a stroke of a movement thread, in particular an output part of the movement thread, and thus of the protective gas nozzle. The synchronous rotation enables precise movement of the protective gas nozzle relative to the laser optics system.

In an embodiment, during the combined lift and rotary movement, the rotary motor rotates, at least in one operating state, and the lift motor is stationary, at least in one operating state. The stationary lift motor requires a stationary input sleeve, which means that one part of the movement thread is stationary, causing a stroke of the output sleeve in addition to the rotary movement of the rotary motor and thus to the rotary movement of the output sleeve. The length of each stroke depends on the rotary movement of the rotary motor.

In an embodiment, during the pure lift movement, the lift motor rotates and the rotary motor does not carry out any movement, thereby preventing, in particular, rotation of the output sleeve. Because the rotary motor is not performing any movement, the part of the output sleeve which forms the output part of the movement thread is prevented from rotating. This ensures that the incoming rotation of the input sleeve results solely in linear movement and not in rotary movement.

In an embodiment, the rotary movement of the output sleeve can be performed as a continuous rotary movement. A continuous rotary movement can be understood to mean that the nozzle exchange coupling can rotate in one direction for any length of time without needing to rotate back to a starting position. This is ensured by the integrated gas routing and/or the integrated compressed air routing, which can be provided without the need for hoses.

Preferred further embodiments of the present disclosure are explained in greater detail by the following description of the figures.

Preferred exemplary embodiments are described below with reference to the figures. In this respect, elements which are the same, similar, or have the same effect are provided with identical reference signs in the various figures, and a repeated description of these elements is omitted.

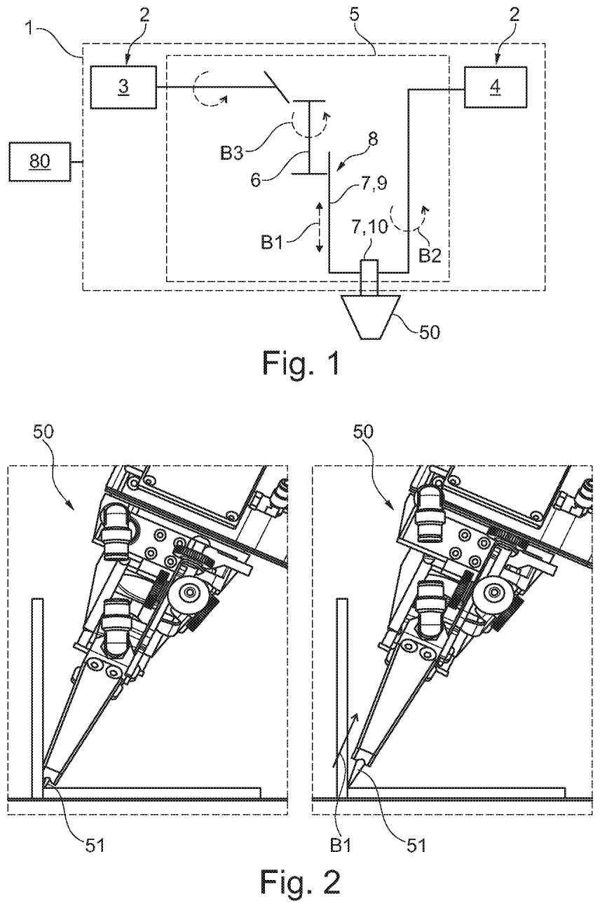

FIG. 1 schematically shows a nozzle exchange coupling 1 for coupling a protective gas nozzle 50 to a laser optics system 80. The nozzle exchange coupling 1 has a motor unit 2 with a lift motor 3 and a rotary motor 4. A lift movement B1 of the protective gas nozzle 50 can be generated by means of the lift motor 3. A rotary movement B2 of the protective gas nozzle 50 can be generated by means of the rotary motor 4. The lift motor 3 and the rotary motor 4 are each connected to a transmission unit 5. The transmission unit 5 has an input sleeve 6 and an output sleeve 7.

The input sleeve 6 and the output sleeve 7 are connected to each other via a movement thread 8. The movement thread 8 can convert a rotation B3 of the input sleeve 6 into a lift movement B1 of the output sleeve 7. In this case, the rotation B3 is the input variable of the movement thread 8 and the lift movement B1 is the output variable. If the input sleeve 6 rotates in a first direction, the output sleeve 7 and the protective gas nozzle 50 coupled thereto perform a stroke in a first direction; if the input sleeve 6 rotates in a second direction, the output sleeve 7 and the protective gas nozzle 50 coupled thereto perform a stroke in a second direction accordingly. The input sleeve 6 can rotate via an interposed transmission connected to the lift motor output shaft. As soon as the lift motor 3 rotates, the input sleeve 6 rotates, causing the protective gas nozzle 50 to perform the lift movement B1 due to the movement thread. If only the lift motor 3 rotates and the rotary motor 4 does not rotate, the protective gas nozzle 50 performs a pure lift movement B1 which is free of rotation.

The output sleeve 7 can rotate via an interposed transmission connected to the rotary motor output shaft. As soon as the rotary motor 4 rotates, the output sleeve 7 rotates. The protective gas nozzle 50 also rotates with the output sleeve 7 and performs the rotary movement B2. In this case, the rotation of the output sleeve 7 also acts as an input variable into the movement thread 8. If the rotary motor 3 does not rotate in this case, and the input sleeve 6 also does not rotate, the rotation of the output sleeve 7 as an input variable results in a translational movement of the movement thread 8, causing the output sleeve 7 to perform a stroke. If only the rotary motor 4 rotates and the lift motor 3 does not rotate, the protective gas nozzle 50 performs a combined lift and rotary movement B1, B2, because the movement thread 8 moves along the stationary input sleeve 6.

In order to generate a pure rotary movement B2, which is free from a stroke, a corresponding movement of the rotary motor 3 and thus of the input sleeve 6 is required. In order for the lift motor 3 to rotate in such a way that a pure rotary movement B2 of the protective gas nozzle 50 is generated when the rotary motor 4 rotates, the lift motor 3 and the rotary motor 4 are kinematically coupled to each other. The kinematic coupling causes the lift motor 3 to rotate in such a way that the rotation of the output sleeve 7 is mirrored as an input variable by a rotation of the input sleeve 6, so that the respective movements are synchronous and the protective gas nozzle 50 does not perform a lift movement B1. The rotation of the lift motor output shaft therefore compensates the stroke of the input sleeve 6, which enables the pure rotary movement B2 of the protective gas nozzle 50. The kinematic coupling can be realized by means of a correspondingly separate control of the two motors 3, 4. It can also be implemented using a mechanical coupling.

FIG. 2 shows the nozzle exchange coupling 1 and the protective gas nozzle 50, which together form a nozzle system 100. As an example, a workpiece fillet is welded. The weld seam extends into the drawing plane. In the left illustration, the protective gas nozzle 50 is arranged in a position near the processing location of a laser beam 51. This allows the process media, such as the protective gas and/or compressed air gas, to be conveyed to the processing location as required by the process. In the case of the workpiece fillet, however, the short distance between the protective gas nozzle and the processing location poses a risk of collision. In this case, the nozzle exchange coupling 1 allows for the lift movement B1. In the right-hand illustration, the protective gas nozzle 50 has performed the lift movement B1 in the direction facing away from the workpiece fillet. The laser beam 51 and its position relative to the laser optics system 80 remained unchanged. Consequently, for example, the focus position is the same in both representations in FIG. 2, which is why the lift movement B1 does not affect the quality of the weld seam. Furthermore, the lift movement B1 eliminates the risk of a collision between the protective gas nozzle 50 and the workpiece, in this case the workpiece fillet.

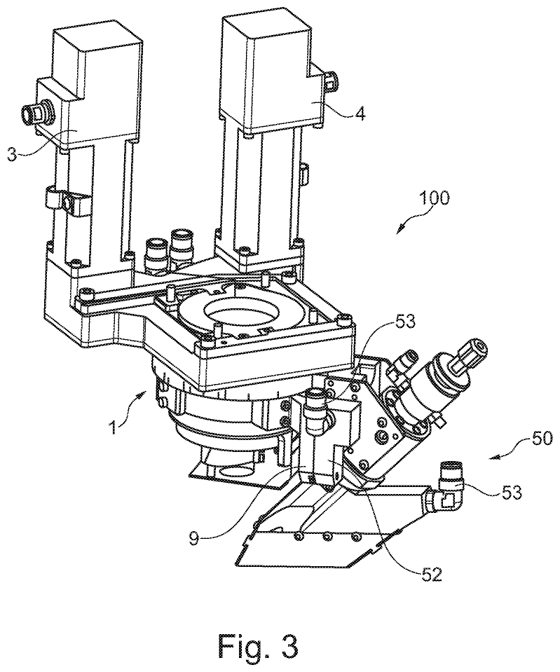

FIG. 3 shows a nozzle exchange coupling 1 with a connected protective gas nozzle 50. The nozzle exchange coupling 1 has a plate-shaped receiving body 9 to which a connecting section 52 of the protective gas nozzle 50 is coupled. The coupling between the nozzle exchange coupling 1 and the protective gas nozzle 50 can be magnetic. The protective gas nozzle 50 has various connections 53, through which the protective gas can be routed. The nozzle exchange coupling 1 has the lift motor 3 and the rotary motor 4. Each of these is housed in its own elongated housing. The length of the housing of the lift motor 3 and/or the rotary motor 4 can be more than half the length of the nozzle exchange coupling 1. This allows for a compact design of the nozzle exchange coupling 1 in the radial direction, which has a beneficial effect on avoiding collisions of the nozzle exchange coupling 1 with the workpiece. The lift motor 3 and the rotary motor 4 can be controlled separately. The nozzle exchange coupling 1 has an opening along the longitudinal axis, through which the laser beam 51, provided by the laser optics systems 80, shines.

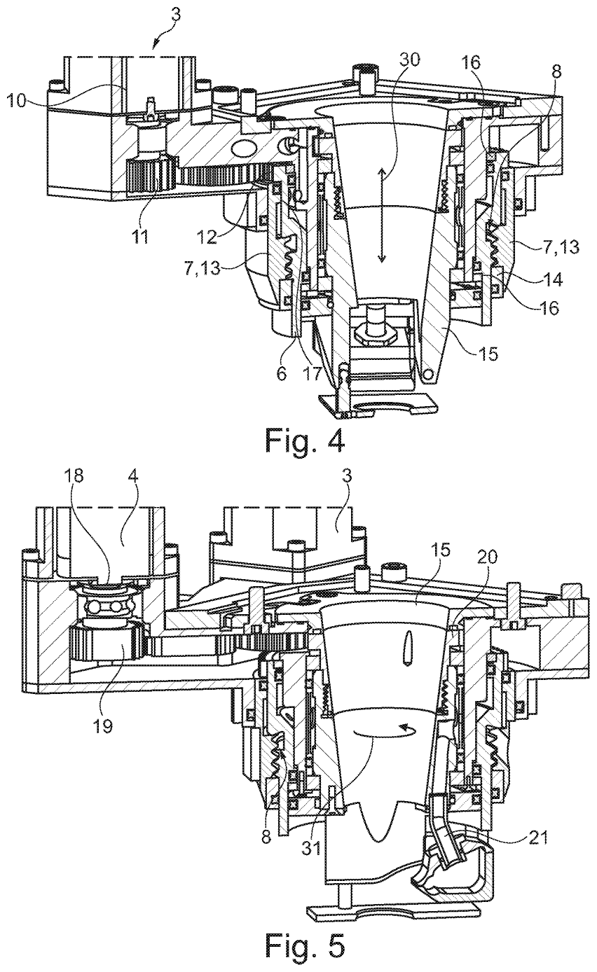

FIG. 4 shows a perspective sectional view through the nozzle exchange coupling 1 with the lift motor 3. A lift motor output shaft 10 is connected to a first transmission input gear 11 of the transmission unit 5. Thus, a rotation of the lift motor 3 is converted into a rotation of the input sleeve 6. For this purpose, the input sleeve 6 has a first threaded collar 12 on its section facing away from the workpiece, which enables the transmission of the rotation to the input sleeve 6, and thus the rotation B3, within a limited installation space. The input sleeve 6 is coupled to the output sleeve 7. The movement thread 8 is arranged between the input sleeve 6 and the output sleeve 7. The movement thread 8 converts the rotation of the input sleeve 6 into the lift movement B1 of the output sleeve 7 when the lift motor 3 is rotating. For this purpose, the output sleeve 7 has a drive nut 13. The drive nut 13 can be connected to a fork ring 14, which prevents the drive nut 13 from rotating when the rotary motor 4 is stationary. The drive nut 13 and the fork ring 14 can be provided radially outside the input sleeve 6. The drive nut 13 is rigidly connected to a compressed air sleeve 15, which is also part of the output sleeve 7, by means of the interposition of the fork ring 14. The lift movement B1 from the drive nut 13 through the movement thread 8 is also carried out by the compressed air sleeve 15. The compressed air sleeve 15 can be provided radially inside the input sleeve 6. To compensate for the relative movement occurring between the input sleeve 6 and the output sleeve 7, rolling bearings 16 and/or sliding bearings 17 are provided between the input sleeve 6 and the output sleeve 7.

FIG. 5 shows a perspective sectional view through the nozzle exchange coupling 1 with the rotary motor 4. A rotary motor output shaft 18 is connected to a second transmission input gear 19 of the transmission unit 5. Thus, a rotation of the rotary motor 4 is converted into a rotation of the compressed air sleeve 15 and thus of the output sleeve 7. For this purpose, the output sleeve 7 has a second threaded collar 20 on the compressed air sleeve 15, which enables the transmission of the rotation to the output sleeve 7, and thus the rotary movement B2, within a limited installation space. The second threaded collar 20 has a smaller diameter than the first threaded collar 12. The movement thread 8 is arranged between the output sleeve 7 and the input sleeve 6. The movement thread 8 also generates a stroke of the output sleeve 7 when the rotary motor 4 is rotating and the lift motor 3 is stationary. This stroke can be compensated by a rotation of the lift motor 3 which is synchronous with the rotation of the rotary motor 4. For this purpose, the lift motor 3 and the rotary motor 4 are kinematically coupled to each other. The compressed air sleeve 15 of the output sleeve 7 has an integrated compressed air routing 21, which is designed to supply compressed air as a crossjet transverse to a laser axis.

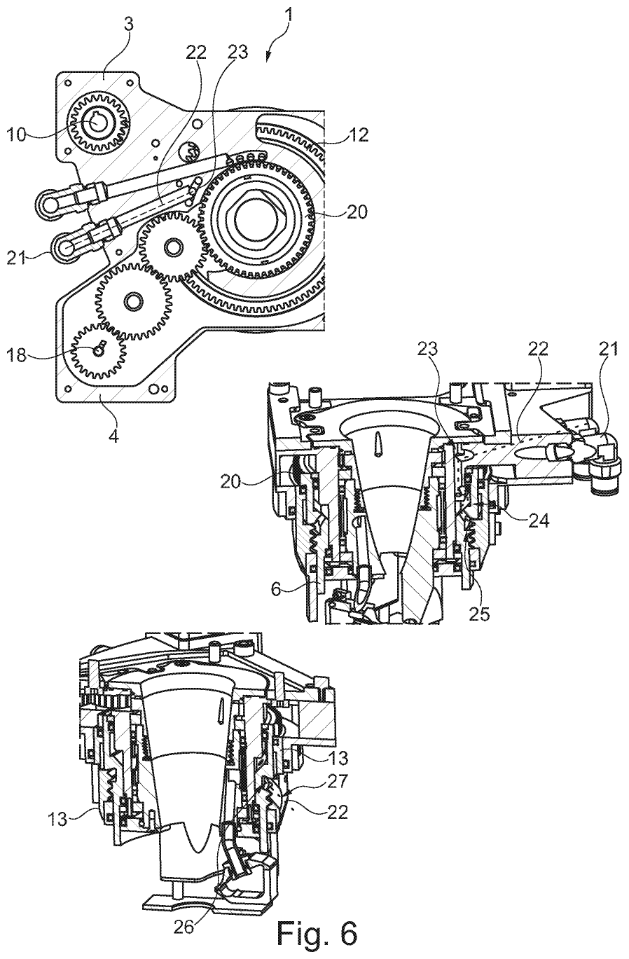

FIG. 6 shows the three representations of the nozzle exchange coupling 1, which illustrate a path 22 of the protective gas. The upper illustration shows a top view of the nozzle exchange coupling 1. Two connections are arranged between the lift motor 3 with the lift motor output shaft 10, which is coupled to the first threaded collar 12, and the rotary motor 4 with the rotary motor output shaft 18, which is coupled to the second threaded collar 20. The connection facing the rotary motor 4 is a protective gas supply connection 21. Protective gas is supplied radially to the nozzle exchange coupling 1 via the protective gas supply connection 21. The protective gas runs along the dashed line 22. At a first protective gas deflection unit 23, the protective gas is redirected in such a way that it runs axially along the laser beam axis. The input sleeve 6 includes an integrated gas routing 24 designed to supply the protective gas to the protective gas nozzle 50. At a second protective gas deflection unit 25, the protective gas is redirected in such a way that it runs in sections along the circumferential direction of the input sleeve 6. A protective gas channel 27 is provided in the drive nut 13 of the output sleeve 7 at a third protective gas deflection unit 26. The protective gas channel 27 and the integrated protective gas routing 24 enable such a deflection of the protective gas that it is supplied from the protective gas channel 27 to the protective gas nozzle 50. This protective gas routing integrated into the nozzle exchange coupling 1 enables hose-free routing of the protective gas in the nozzle exchange coupling. Consequently, the rotary movement B2 of the nozzle exchange coupling can be carried out continuously because no hoses become twisted.

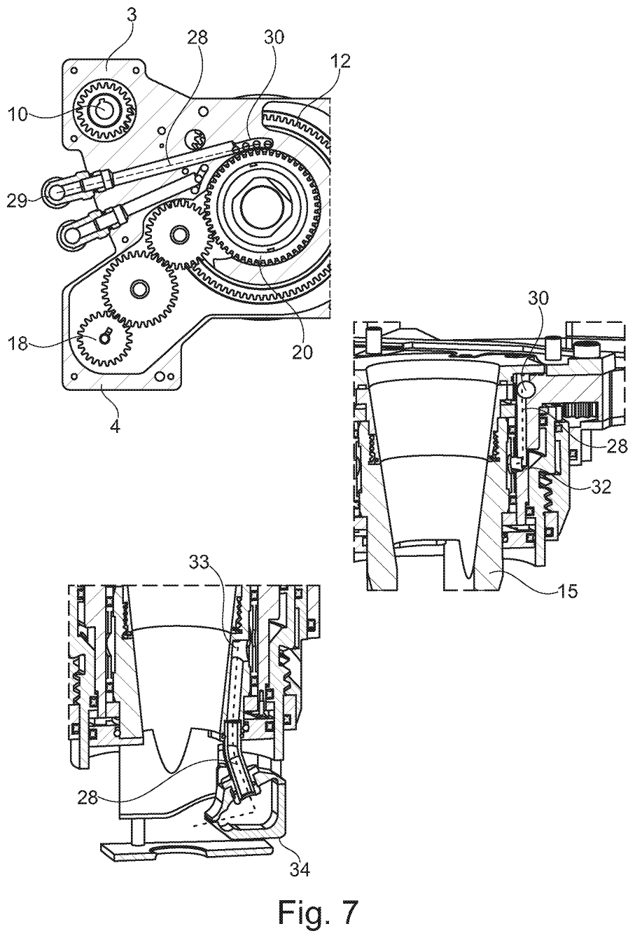

FIG. 7 shows three representations of the nozzle exchange coupling 1, which illustrate a path 28 of the compressed air. The upper illustration shows a top view of the nozzle exchange coupling 1. Two connections are arranged between the lift motor 3 with the lift motor output shaft 10, which is coupled to the first threaded collar 12, and the rotary motor 4 with the rotary motor output shaft 18, which is coupled to the second threaded collar 20. The connection facing the lift motor 3 is a compressed air supply connection 29. Compressed air is supplied radially to the nozzle exchange coupling 1 via the compressed air supply connection 29. The compressed air flows along the dashed line 28. At a first compressed air deflection unit 30, the compressed air is redirected in such a way that it runs axially along the laser beam axis. The compressed air sleeve 15 of the output sleeve 7 has an integrated compressed air routing 31, which is designed to guide the compressed air at least in sections into the nozzle exchange coupling 1 and to supply the compressed air transversely to the laser axis as a crossjet. The compressed air is redirected to a second compressed air deflection unit 32 in such a way that it flows in parts along the circumferential direction of the output sleeve 7. A third compressed air deflection unit 33 is provided in the compressed air sleeve 15 of the output sleeve 7 for the input of the integrated compressed air routing 31. From there, the compressed air is supplied to an end 34 of the compressed air sleeve 15 facing the workpiece, from where it can be supplied to the laser beam in the manner of a crossjet. The end 34 of the compressed air sleeve 15 can have a chamber for collecting compressed air. This compressed air routing integrated into the nozzle exchange coupling 1 ensures a reliable and robust compressed air supply.

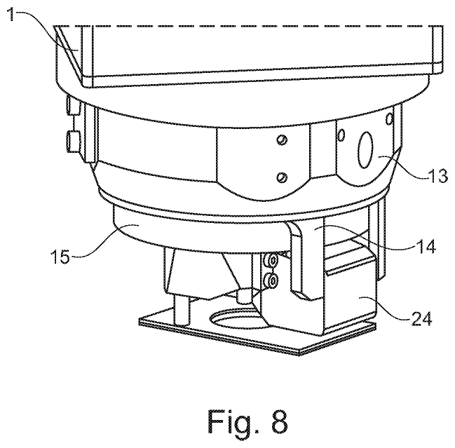

FIG. 8 shows the nozzle exchange coupling 1 in a perspective outer view. The drive nut 13 of the output sleeve 7 is connected to the end 34 of the compressed air sleeve 15 via the fork ring 14. The fork ring 14 prevents the drive nut 13 from rotating during the rotation B3 of the input sleeve 6, for example due to frictional forces in the movement thread 8. This ensures that, in an operating state in which the lift motor 3 rotates and the rotary motor 4 does not rotate, the output sleeve 7 performs a pure stroke. In an operating state, in which the rotary motor 4 rotates and drives the output sleeve 7, the fork ring 14 rotates together with the compressed air sleeve 15 and the drive nut 13. The fork ring 14 can have two protrusions which clamp the end 34 of the compressed air sleeve 15 along the circumferential direction from both sides and thus fix it in a rotationally fixed manner.

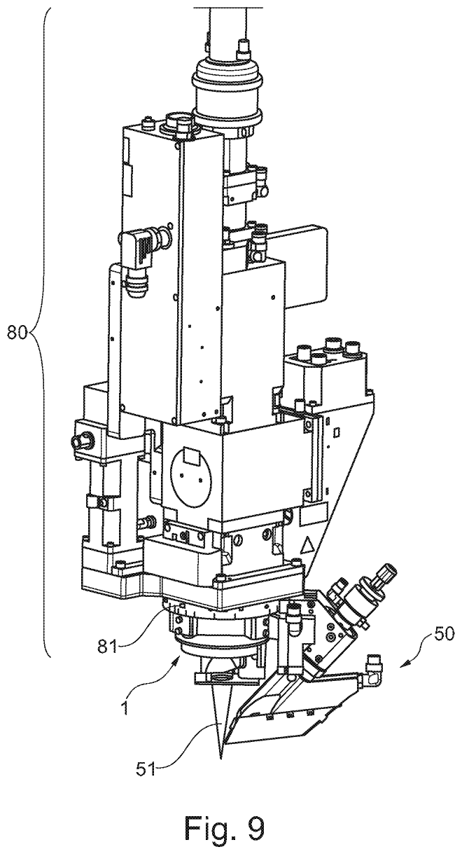

FIG. 9 shows the nozzle system 100 with the nozzle exchange coupling 1, the protective gas nozzle 50 and the laser optics system 80. The laser optics system 80 has a rotary module 81, to which the nozzle exchange coupling 1 is rigidly connected. In this way, a rotation of the laser optics system 80 is transferred to the nozzle exchange coupling 1. This rotation, however, is independent of the movements B1, B2, B3 described here. The laser beam 51 emerges from the laser optics system 80. The coupling of the protective gas nozzle 50 with the nozzle exchange coupling 1 as disclosed enables a relative movement of the protective gas nozzle 50 to the laser optics system 80. The coupling is robust, error-free, and weight-saving.

Insofar as applicable, all individual features presented in the exemplary embodiments can be combined with one another and/or interchanged, without departing from the scope of the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Nozzle exchange coupling
2 Motor unit
3 Lift motor
4 Rotary motor
5 Transmission unit
6 Input sleeve
7 Output sleeve
8 Movement thread
9 Plate-shaped receiving body
10 Lift motor output shaft
11 First transmission input gear
12 First threaded collar
13 Drive nut
14 Fork ring
15 Compressed air sleeve
16 Rolling bearing
17 Sliding bearing
18 Rotary motor output shaft
19 Second transmission input gear
20 Second threaded collar
21 Protective gas supply connection
22 Path of the protective gas
23 First protective gas deflection unit
24 Integrated protective gas routing
25 Second protective gas deflection unit
26 Third protective gas deflection unit
27 Protective gas channel
28 Path of the compressed air
29 Compressed air supply connection
30 First compressed air deflection unit
31 Integrated compressed air routing
32 Second compressed air deflection unit
33 Third compressed air deflection unit
34 End of the compressed air sleeve
50 Protective gas nozzle
51 Laser beam
52 Connection section
53 Connection
80 Laser optics system
81 Rotary module
100 Nozzle system
B1 Lift movement
B2 Rotary movement
B3 Rotation of the input sleeve

1. A nozzle exchange coupling for coupling a protective gas nozzle to a laser optics system, comprising:
a motor unit with a lift motor configured to generate a lift movement of the protective gas nozzle and a rotary motor configured to generate a rotary movement of the protective gas nozzle; and
a transmission unit with an input sleeve which is coupled at least to the lift motor and an output sleeve which is coupled at least to the rotary motor, the output sleeve being configured to contribute to supplying of a protective gas to the protective gas nozzle.

2. The nozzle exchange coupling according to claim 1, wherein the input sleeve and the output sleeve are connected via a movement thread of a transmission which is configured to convert a rotation of the input sleeve into the lift movement of the protective gas nozzle.

3. The nozzle exchange coupling according to claim 1, wherein the lift motor and the rotary motor are kinematically coupled to each other and/or the lift motor and the rotary motor are configured to be controlled separately from each other.

4. The nozzle exchange coupling according to claim 1, wherein the lift motor and the rotary motor are connected to a controller, via which the lift motor and the rotary motor are configured to be controlled such that the protective gas nozzle performs only the rotary movement, only the lift movement, or a combination of the lift movement and the rotary movement.

5. The nozzle exchange coupling according to claim 4, wherein a rotation of the lift motor is configured to be synchronized with a rotation of the rotary motor to compensate for a stroke of the movement thread and the protective gas nozzle based on the protective gas nozzle performing only the rotary movement.

6. The nozzle exchange coupling according to claim 4, wherein the rotary motor is configured to rotate and the lift motor is configured to be stationary based on the protective gas nozzle performing the combination of the lift movement and the rotary movement.

7. The nozzle exchange coupling according to claim 4, wherein the lift motor is configured to rotate and the rotary motor is configured to be stationary based on the protective gas nozzle performing only the lift movement, thus preventing a rotation of the output sleeve.

8. The nozzle exchange coupling according to claim 1, wherein the output sleeve has a drive nut and a compressed air supply sleeve, wherein the drive nut is arranged at least partially radially outside the input sleeve and/or wherein the compressed air supply sleeve is arranged at least partially radially inside the input sleeve.

9. The nozzle exchange coupling according to claim 8, wherein the drive nut and the compressed air supply sleeve are rigidly connected to each other via a fork ring.

10. The nozzle exchange coupling according to claim 8, wherein the input sleeve includes an integrated gas routing configured to supply the protective gas to the protective gas nozzle and/or wherein the rotary movement is configured to be carried out as a continuous rotary movement.

11. The nozzle exchange coupling according to claim 8, wherein the compressed air supply sleeve is configured as a crossjet sleeve which includes an integrated compressed air routing configured to supply compressed air as a crossjet transverse to a laser axis.

12. A nozzle system comprising a nozzle exchange coupling according to claim 1 and the laser optics system, wherein the motor unit is independent of the laser optics system, such that the protective gas nozzle is configured to be moved relative to the laser optics system by the lift movement and/or the rotary movement.

13. A laser system for processing a workpiece, comprising the nozzle system according to claim 12.

14. A method for moving a nozzle exchange coupling for coupling a protective gas nozzle to a laser optics system, the nozzle exchange coupling including:
a motor unit with a lift motor configured to generate a lift movement of the protective gas nozzle and a rotary motor configured to generate a rotary movement of the protective gas nozzle, and
a transmission with an input sleeve which is coupled at least to the lift motor and an output sleeve which is coupled at least to the rotary motor, the output sleeve being configured to contribute to supplying of a protective gas to the protective gas nozzle,
the method comprising one or more of:
performing a pure lift movement of the protective gas nozzle by exclusively rotating the lift motor;
performing a combined lift and rotary movement of the protective gas nozzle by exclusively rotating the rotary motor; and/or
performing a pure rotary movement of the protective gas nozzle by rotating the rotary motor and the lift motor.

15. The method according to claim 14, comprising synchronizing a rotation of the lift motor with a rotation of the rotary motor to compensate for a stroke of a movement thread and thus of the protective gas nozzle during the pure rotary movement.

16. The method according to claim 14, comprising, during the combined lift and rotary movement, rotating the rotary motor in at least one operating state and not moving the lift motor in at least one operating state.

17. The method according to claim 14, comprising, during the pure lift movement, rotating the lift motor and not performing any movement with the rotary motor, thereby preventing a rotation of the output sleeve.

18. The method according to claim 14, wherein the rotary movement is carried out as a continuous rotary movement.
